(19) United States
(12) Patent Application Publication
(10) Pub. No.: US 2016/0153524 A1
(43) Pub. Date: Jun. 2, 2016

(54) CONTINUOUSLY VARIABLE TRANSMISSION BELT

(71) Applicant: HONDA MOTOR CO., LTD., Tokyo (JP)

(72) Inventors: Taiki Ando, Wako-shi (JP); Toru Yagasaki, Wako-shi (JP)

(73) Assignee: HONDA MOTOR CO., LTD., Tokyo (JP)

(21) Appl. No.: 14/905,366

(22) PCT Filed: Jul. 10, 2014
(86) PCT No.: PCT/JP2014/068425

§ 371 Date: Jan. 15, 2016

(30) Foreign Application Priority Data
Jul. 18, 2013 (JP) 2013-149849

(51) Int. Cl. F16G 5/16

(52) U.S. Cl. CPC F16G 5/16

(57) ABSTRACT

The present invention achieves both reducing a friction coefficient of a metal ring and improving a durability of the same provided to a metal belt of a continuously variable transmission. A continuously variable transmission belt supports a plurality of metal elements to a metal ring assembly obtained by laminating a plurality of metal rings, and is provided with an uneven surface having a plurality of projecting portions and a plurality of valley portions formed between the plurality of projecting portions on an inner peripheral surface of the metal ring of an innermost periphery. A low-friction coefficient layer having a lower friction coefficient on a surface thereof than a friction coefficient on a surface of the projecting portion is formed on the valley portion on the uneven surface. The low-friction coefficient layer can be a layer having a fluoridated layer or a DLC layer.

### TECHNICAL FIELD

The present invention relates to a continuously variable transmission belt supporting a plurality of metal elements to a metal ring assembly obtained by laminating a plurality of metal rings in order to transmit a driving force between a drive pulley and a driven pulley.

### BACKGROUND ART

Some continuously variable transmission belts support a plurality of metal elements to a metal ring assembly obtained by laminating a plurality of metal rings in order to transmit a driving force between a drive pulley and a driven pulley. Conventional examples of the belts are shown in Patent References 1 and 2.

Patent Reference 1 shows a high speed sliding member on which a DLC (Diamond-like Carbon) film including a granular projection on a metal member having a given roughness on a surface thereof is coated as a high speed sliding member which an stick slip is unlikely to occur and a friction coefficient can be reduced.

Patent reference 2 shows a continuously variable transmission belt which a mountainous projection is formed on an inner peripheral surface of a metal ring of the innermost periphery as the continuously variable transmission belt for improving a durability of the metal ring. In the continuously variable transmission belt, when the mountainous projection formed on the inner peripheral surface of the metal ring is initially worn, an average contact length of the projection measured in a direction at a right angle against an advancing direction is set to be a given dimension, and an occurrence of a crack can be prevented.

### RELATED ART DOCUMENTS

### Patent Documents

[Patent document 1]: Japanese Patent No. 4918972

[Patent document 2]: Japanese Patent No. 4078126

### DISCLOSURE OF THE INVENTION

### Problems to be Solved by the Invention

According to the high speed sliding member on which the DLC film is coated described in Patent Reference 1, a friction resistance of the high speed sliding member can be reduced. On the other hand, according to a configuration described in Patent Reference 2, an occurrence a crack can be prevented to improve a durability of the metal ring. However, the continuously variable transmission belt has not had both a structure for reducing a friction resistance of a metal ring and a structure for improving a durability of the metal ring in conventional inventions.

The present invention is achieved in view of the above-described problems, and the purpose of the invention is to provide a continuously variable transmission belt capable of achieving both reducing a friction resistance of the metal ring and improving a durability of the same.

### Means of Solving the Problem

To solve the above described problem, a continuously variable transmission belt according to the present invention, in order to transmit a driving force between a drive pulley (6) and a driven pulley (11), supports a plurality of metal elements (32) to a metal ring assembly (31) obtained by laminating a plurality of metal rings (33). The continuously variable transmission belt (15) has an uneven surface (38) including a plurality of projecting portions (38a) formed on a surface (33a) of the metal ring (33) and a plurality of valley portions (38b) formed between the plurality of projecting portions (38a), and on the valley portions (38b) on the uneven surface (38), a low-friction coefficient layer (51) having a lower friction coefficient on a surface thereof than a friction coefficient of a surface of the projecting portion (38a) is formed. In addition, in the continuously variable transmission belt, the uneven surface (38) may be configured by crossing the plurality of mountainous projecting portions (38a) extending in an oblique direction to a travel direction of the metal ring (33) with each other in a meshed state.

According to the continuously variable transmission belt of the present invention, a friction coefficient of a surface of the metal ring can be suppressed low by the low-friction coefficient layer formed on the valley portions of the uneven surface of the metal ring, thereby a friction resistance caused by a slide between the metal rings or the metal ring and the metal element can be reduced. Moreover, since the uneven surface having the plurality of projecting portions and the plurality of valley portions is formed on a surface of the metal ring, a pitching occurred on a top of the projecting portion when the projecting portion is initially worn can be prevented from extending in a depth direction by setting an average contact length of a lateral direction (a width direction) of the projecting portion after the initial wear to be a given dimension. This enables to prevent an occurrence of a crack on the projecting portion and improve a durability of the metal ring. Accordingly, improving a durability of the metal ring and reducing a friction resistance of the same can be achieved to provide the continuously variable transmission belt having a high strength and a high efficiency (a high transmission efficiency).

In addition, in the above-described continuously variable transmission belt, the uneven surface (38) is preferably formed on at least the inner peripheral surface (33a) of the metal ring (33) of the innermost periphery of the plurality of metal rings (33) which configures the metal ring assembly (31).

In the continuously variable transmission belt of the above-described configuration, as a friction resistance due to a differential rotation between the members generated internally, the friction resistance generated on a contact position of an inner peripheral surface of the metal ring of the innermost periphery and the metal element is the largest. Whereas, according to the above-described configuration in accordance with the present invention, the uneven surface is formed on the inner peripheral surface of the metal ring of the innermost periphery and the low-friction coefficient layer is formed on a valley portion of the uneven surface, thereby the friction coefficient of an inner peripheral surface of the metal ring can be suppressed low. This enables to reduce a friction resistance generated between the metal ring assembly and the metal element, and a power transmission efficiency (a belt efficiency) of the continuously variable transmission belt can be improved to provide a continuously variable transmission belt having a high strength and a high efficiency.

Additionally, in the above-described continuously variable transmission belt, a nitrided layer (52) is preferably formed as an underlayer of the low-friction coefficient layer (51).

In addition, in the above-described continuously variable transmission belt, the low-friction coefficient layer (51) can be a fluoridated layer (51a).

When the fluoridated layer due to a fluoridation is formed as the low-friction coefficient layer for reducing a friction coefficient of the metal rings, the low-friction coefficient layer according to the present invention can be formed by performing a second fluoridation as a following process of the nitridation after the fluoridation in the nitridation. Accordingly, a necessity of adding equipment and changing a process required to the fluoridation for forming the low-friction coefficient layer can be eliminated, which enables to avoid rising of manufacturing cost for the metal ring on which the low-friction coefficient layer is formed and the continuously variable transmission belt provided with the same.

Furthermore, in a case of the fluoridation, the fluoridated layer is replaced with the nitrided layer when the fluoridation is performed before the nitridation, whereas the fluoridated layer is not replaced with the nitrided layer and the fluoridated layer can be securely formed by performing a surface treatment by the fluoridation after the nitridation. Accordingly, by performing the fluoridation after the nitridation, the fluoridated layer capable of effectively reducing a friction coefficient of the metal rings can be formed on the valley portion of the uneven surface.

Whereas, the low-friction coefficient layer (51) can be a layer (51b) having a DLC (Diamond-like Carbon) firm.

When a layer including the DLC film superior in a surface slidability as the low-friction coefficient layer is formed on the valley portion on the uneven surface of the metal ring, a friction coefficient of the metal ring can be effectively reduced.

In addition, the above-described symbols in parentheses show the symbols of components in embodiments described below as an example of the present invention.

### Effects of the Invention

According to a continuously variable transmission belt in accordance with the present invention, both reducing a friction coefficient of the metal ring and improving a durability of the same can be achieved to provide the continuously variable transmission belt having a high strength and a high efficiency.

### BRIEF DESCRIPTION OF THE DRAWINGS

FIG. 1 is a skeleton view of a power transmission system of a vehicle on which a metal belt continuously variable transmission is mounted in accordance with an embodiment of the present invention.

FIG. 2 is a partial perspective view showing a part of a metal belt.

FIG. 3 is a perspective view showing a metal ring of the innermost periphery.

FIG. 4 shows an uneven surface and a low-friction coefficient layer formed on an inner peripheral surface of the metal ring. FIG. 4A is a plane view of the uneven surface (a Y arrow view of FIG. 3), and FIG. 4B is a sectional side view of the uneven surface (a Z-Z arrow sectional view of FIG. 4A).

FIG. 5 describes a friction force due to a differential rotation generated between the adjacent metal rings or the metal ring of an innermost periphery and the metal element. FIG. 5 is a sectional view of the metal ring and the metal element (an X-X arrow sectional view of FIG. 2).

FIG. 6 schematically shows an actual contact surface by a boundary film between an inner peripheral surface of the metal ring of the innermost periphery and a saddle surface of the metal element.

FIG. 7 describes about the boundary film. FIG. 7A shows a case where there is one type of the boundary film, and FIG. 7B shows a case where there are two types of boundary films.

FIG. 8 describes a process of a surface treatment for forming a low-friction coefficient layer.

FIG. 9 is a graph for showing a comparison of a power transmission efficiency (a belt efficiency) of the metal belt in a case where there is a fluoridated layer and there is no fluoridated layer.

FIG. 10 is a graph for showing a comparison of a friction coefficient of a V surface of a pulley in a case where there is a fluoridated layer and there is no fluoridated layer.

FIG. 11 shows the power transmission efficiency (the belt efficiency) of the metal rings in a case where there is a layer having a DLC film and there is not the DLC layer.

### MODE FOR CARRYING OUT THE INVENTION

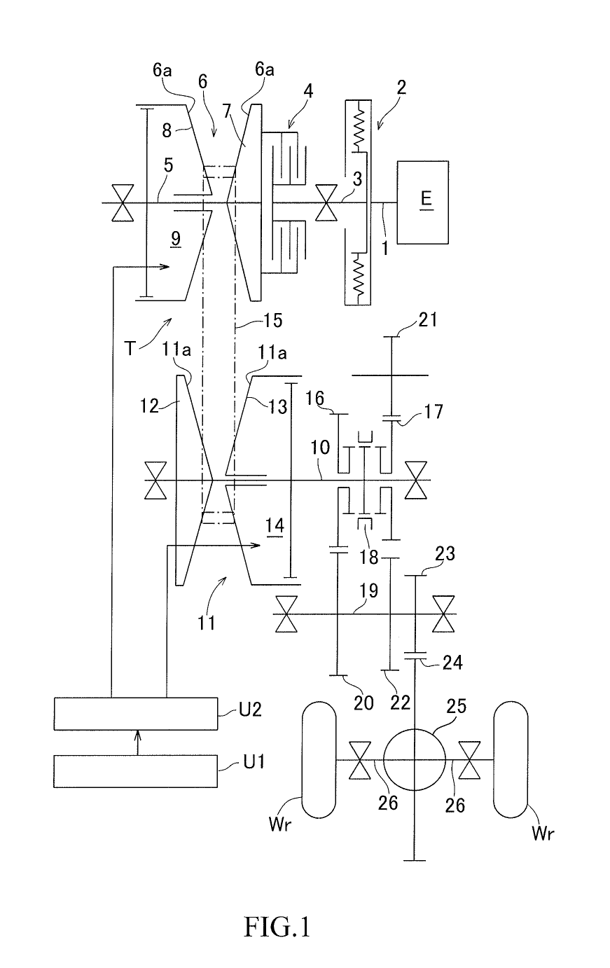

Embodiments of the present invention are described hereinafter referring to attached drawings. FIG. 1 is a skeleton view of a power transmission system of a vehicle on which a metal belt continuously variable transmission is mounted in accordance with an embodiment of the present invention.

As shown in FIG. 1, in a metal belt continuously variable transmission T of the present embodiment, an input shaft 3 connected to a crank shaft 1 of an engine E through a damper 2 is connected to a drive shaft 5 of the metal belt continuously variable transmission T through a starting clutch 4. A drive pulley 6 provided on a drive shaft 5 is has a fixed-side pulley half body 7 fixed to the drive shaft 5 and a movable-side pulley haft body 8 capable of contacting with and separating from the fixed-side pulley half body 7. The movable-side pulley haft body 8 is energized toward the fixed-side pulley half body 7 by oil pressure acting on an oil camber 9.

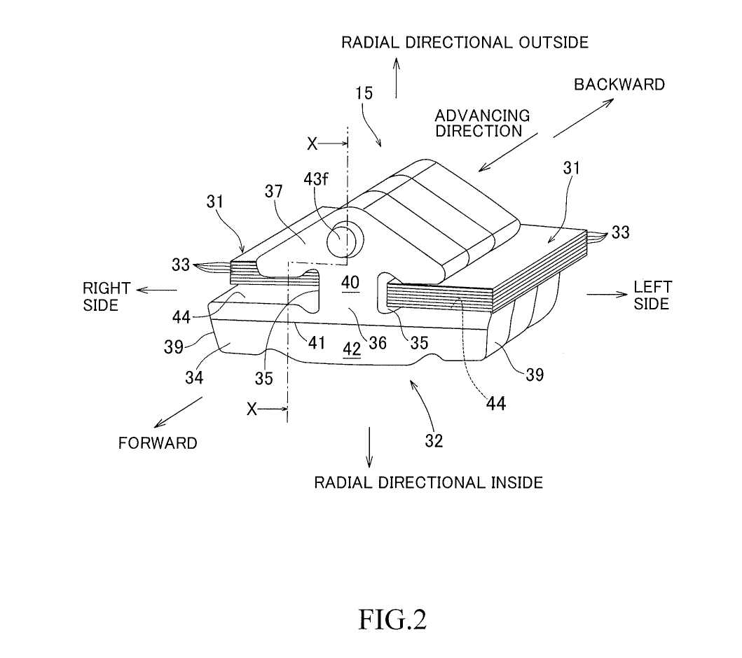

A driven pulley 11 provided on a driven shaft 10 disposed in parallel to the drive shaft 5 is provided with a fixed-side pulley half body 12 fixed to the driven shaft 10 and a movable-side pulley half body 13 capable of contacting with and separating from the fixed-side pulley half body 12. The movable-side pulley haft body 13 is energized toward the fixed-side pulley half body 12 by oil pressure acting on an oil camber 14. A metal belt 15 supporting a number of metal elements 32 to a pair of left and right metal ring assemblies 31, 31 (FIG. 2 is referred to.) is wound between the drive pulley 6 and the driven pulley 11. Each metal ring assembly 31 is formed by laminating twelve pieces of metal rings 33. In addition, the number of the laminated metal rings 33 is not restricted to twelve pieces.

A forward drive gear 16 and a reverse drive gear 17 are relatively and rotatably supported to the driven shaft 10. The forward drive gear 16 and the reverse drive gear 17 can be selectively connected to the driven shaft 10 by a selector 18. A forward driven gear 20 engaged with the forward drive gear 16 and a reverse driven gear 22 engaged with the reverse drive gear 17 through a reverse idle gear 21 are fixed to an output shaft 19 disposed in parallel to the driven shaft 10.

A rotation of the output shaft 19 is input to a differential 25 through a final drive gear 23 and a final driven gear 24, and transmitted to a drive wheels Wr, Wr through left and right axles 26, 26.

In addition, a driving force of the Engine E is transmitted to the driven shaft 10 through the crack shaft 1, the damper 2, the input shaft 3, the starting clutch 4, the drive shaft 5, the drive pulley 6, the metal belt 15 and the driven pulley 11. When a forward travel range is selected, a driving force of the driven shaft 10 is transmitted to the output shaft 19 through the forward drive gear 16 and the forward driven gear 20, and the vehicle travels forward. In addition, when a reverse travel range is selected, a driving force of the driven shaft 10 is transmitted to the output shaft 19 through the reverse drive gear 17, the reverse idle gear 21, and the reverse driven gear 22, and the vehicle travels backward.

At this time, an oil pressure acting on the oil chamber 9 of the drive pulley 6 and the oil chamber 14 of the driven pulley 11 of the metal belt continuously variable transmission T is controlled by an hydraulic control unit U2 operated by a command from an electronic control unit U1, thereby the gear ratio is continuously adjusted. That is, when the oil pressure acting on the oil chamber 14 of the driven pulley 11 is relatively increased more than the oil pressure acting on the oil chamber 9 of the drive pulley 6, a groove width of the driven pulley 11 is decreased and an effective radius is increased, accordingly a groove width of the drive pulley 6 is increased and the effective radius is decreased, thereby the gear ratio of the metal belt continuously variable transmission T continuously changes toward LOW. On the contrary, when the oil pressure acting on the oil chamber 9 of the drive pulley 6 is relatively increased more than the oil pressure acting on the oil chamber 14 of the driven pulley 11, the groove width of the drive pulley 6 is decreased and the effective radius is increased, accordingly the groove width of the driven pulley 11 is increased and the effective radius is decreased, thereby the gear ratio of the metal belt continuously variable transmission T continuously changes toward OD.

FIG. 2 is a partial perspective view showing a part of the metal belt 15. A definition of a longitudinal direction, a lateral direction, and a radial direction of the metal element 32 used in the present embodiment is shown in FIG. 2. The radial direction is defined as radial directions of the pulleys 6, 11 on which the metal element 32 abuts. (FIG. 1 is referred to.) A side which is closer to rotation shafts of the pulleys 6, 11 (the drive shaft 5 or the driven shaft 10) is a radial directional inside, and a side which is farther from the rotation shafts of the pulleys 6, 11 is a radial directional outside. In addition, the lateral direction is defined as a direction along the rotation shaft of the pulleys 6, 11 on which the metal element 32 abuts, and the longitudinal direction is defined as a direction along an advancing direction of the metal element 32 when the vehicle travels forward.

As shown in FIG. 2, the metal element 32 formed by punching from a metal plate has an element main body 34 having an approximately trapezoidal form, a neck portion 36 positioned between a pair of left and right ring slots 35, 35 with which the metal ring assemblies 31, 31 are engaged, and an ear portion 37 having an approximately triangle shape connected to an upper portion of the element main body 34 through the neck portion 36. A pair of pulley abutting surfaces 39, 39 capable of abutting on a V surfaces 6a, 11 a of the drive pulley 6 and the driven pulley 11 are formed on both end portions in a lateral direction of the element main body 34. In addition, main surfaces 40 abutting each other are respectively formed on a front side and a back side of an advancing direction of the metal element 32, furthermore, an inclined surface 42 is formed on a lower portion of the main surface 40 on the front side of the advancing direction through a rocking edge 41 extending in a lateral direction. Moreover, in order to connect the metal elements 32, 32 longitudinally adjacent to each other, a projected portion 43f and a recessed portion (not shown) capable of engaging with each other are formed on a front and back surfaces of the ear portion 37. And saddle surfaces 44, 44 for supporting an inner peripheral surface of the metal ring assemblies 31, 31 (an inner peripheral surface 33a of the metal ring 33 of the innermost periphery) are formed on a lower edge of the left and right ring slots 35, 35.

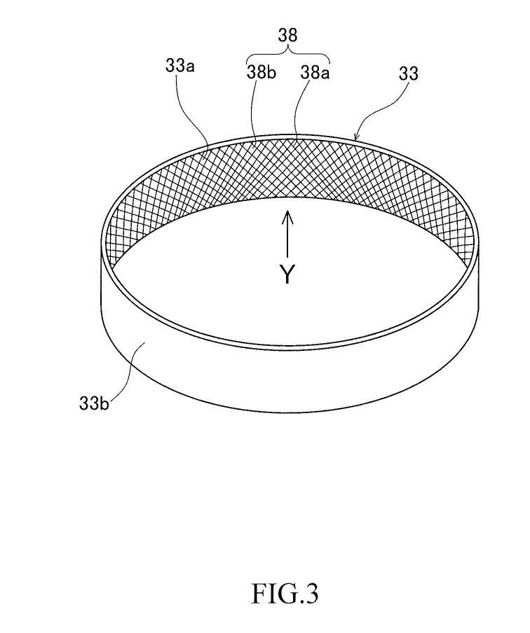

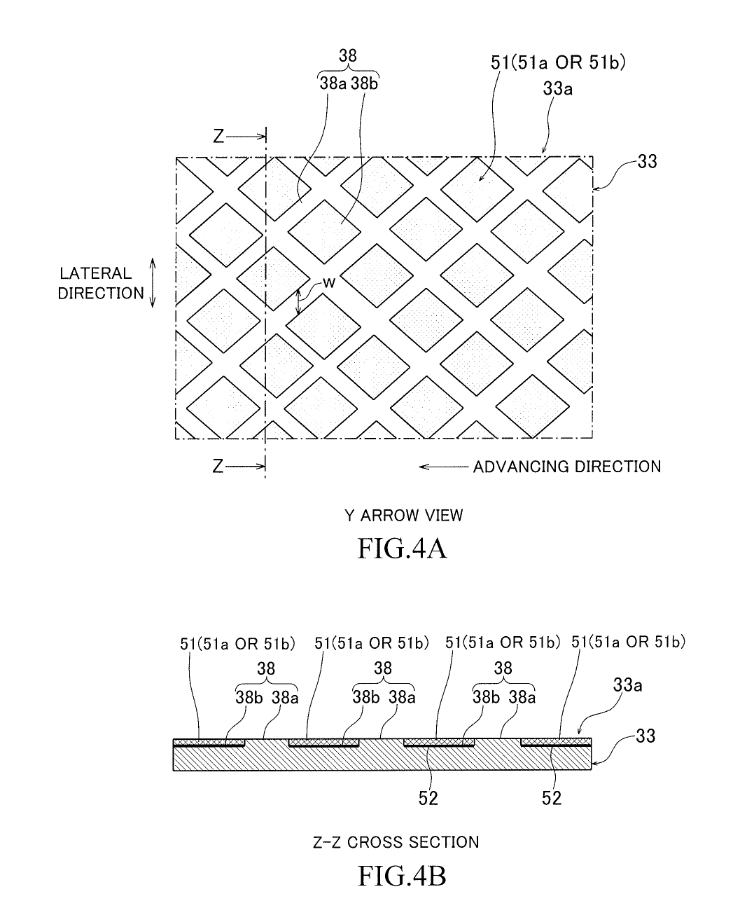

FIG. 3 is a perspective view showing the inner peripheral surface 33a of the metal ring 33 of the innermost periphery. FIG. 4 is an enlarged view of an uneven surface 38 and a low-friction coefficient layer 51 formed on the inner peripheral surface 33a of the metal ring 33 of the innermost periphery. FIG. 4A is a plane view, and FIG. 4B is a sectional side view. As shown in FIG. 3 and FIG. 4, the uneven surface 38 having a plurality of projecting portions 38a and a plurality of valley portions 38b is formed on an inner peripheral surface 33a of the metal ring 33 of the innermost periphery. The uneven surface 38 has a configuration where a plurality of mountainous projecting portions 38a extending in an oblique direction to an advancing direction of the metal ring 33 are crossed with each other in a meshed state, and the valley portion 38b lower than the projecting portion 38a is formed between the projecting portions 38a. In addition, on the uneven surface 38, the plurality of mountainous projecting portions 38a respectively extending straight by separating in a direction at a right angle against the advancing direction of the metal ring 33 are disposed so that at least a part of the plurality of projecting portions 38a is crossed. Thus, the whole of the projecting portions 38a formed on the uneven surface 38 are formed in a meshed state.

The metal ring 33 is curved at a part wound around the drive pulley 6 and the driven pulley 11, and extended straight at a part of a chord between the drive pulley 6 and the driven pulley 11. Thereby, a crack easily occurs in a vicinity of a top of the projecting portion 38a where an amplitude of a bending stress is the largest, in addition, an occurrence direction and a growth direction of the crack is a lateral direction. (A direction orthogonal to an advancing direction of the metal ring 33.) Especially, in a part where two projecting portions 38a, 33a approximately orthogonal with each other are crossed, since widths of the projecting portions 38a, 33a measured in an advancing direction becomes wider, a lubricity is deteriorated and a crack easily occurs.

On the other hand, when an average contact length w of a lateral direction in the projecting portion 38a after an initial wear is set to be equal to or lower than a given dimension, an occurrence of a crack can be prevented. The reason is that, even when a pitching is occurred on a top of the projecting portion 38a which is narrow, the pitching is not extended in a depth direction because the width of the top of the projecting portion 38a is narrow, thereby a shallow pitching is scraped off and eliminated by contacting with the metal element 32 and the saddle surface 44. In addition, when a width of the projecting portion 38a measured in a direction at a right angle against an advancing direction of the metal ring 33 is set to be narrow, a width of the projecting portion 38a measured in the advancing direction is also narrowed, thereby an oil film on the top of the projecting portion 38a is prevented from running out and an occurrence of a crack is prevented. When the metal ring 33 and the metal element 32 is attached, an average hertz surface pressure is lowered and a pitching is prevented. Furthermore, the top of the projecting portion 38a is worn and a surface roughness is highly improved to improve a lubricity and a further wear is stopped progressing. Accordingly, in the present embodiment, a dimension and a shape of the projecting portion 38a is set in order for the average contact length w of a lateral direction in the projecting portion 38a after the initial wear to be equal to or lower than a given dimension (preferably, 16 μm).

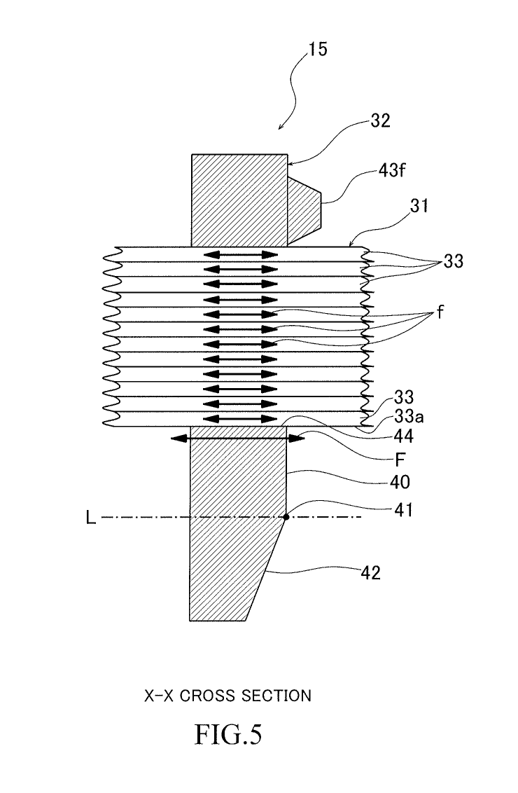

FIG. 5 describes a friction force due to a differential rotation generated between adjacent metal rings 33 or the metal ring 33 of an innermost periphery and the metal element 32. FIG. 5 is a sectional view of the metal ring 33 and the metal element 32 (an X-X arrow sectional view of FIG. 2). As shown in this figure, when the metal belt 15 is curved, on an outer diameter side (an outside of a radial direction) of a pitch line L (which passes through the rocking edge 41), a differential rotation (a slip by a peripheral speed difference) and a friction force in accordance with the differential rotation are generated between adjacent metal rings 33 of the plurality of metal rings 33 configuring the ring assembly 31 or the inner peripheral surface 33a of the metal ring 33 of the innermost periphery and the saddle surface 44 of the metal element 32 opposing to the inner peripheral surface 33a. The differential rotation is generated as a differential rotation of a quantity in accordance with a distance from the pitch line L. In FIG. 5, a friction force due to a differential rotation generated between the adjacent metal rings 33 is set as f, and a friction force due to a differential rotation generated between the inner peripheral surface 33a of the metal ring 33 of the innermost periphery and the saddle surface 44 of the metal element 32 opposing to the inner peripheral surface 33a is set as F.

Accordingly, in the present embodiment, as shown in FIG. 4, as a countermeasure to reduce the friction coefficient of the metal ring 33, a surface treatment capable of reducing the friction coefficient is applied to a surface of the metal ring 33. Specifically, the low-friction coefficient layer 51 having a friction coefficient lower than a friction coefficient on a surface of the projecting portion 38a is formed on a surface of the valley portion 38b on the uneven surface 38 formed on the inner peripheral surface 33a of the metal ring 33. The low-friction coefficient layer 51 may be a layer 51b including a fluoridated layer 51a described below or the DLC film. Thus, a boundary layer (a boundary film) between the metal ring 33 and the metal element 32 is configured so as to be a double layer (two types of boundary films) of the low-friction coefficient layer 51 and the surface layer of the projecting portion 38a (a high-friction coefficient layer).

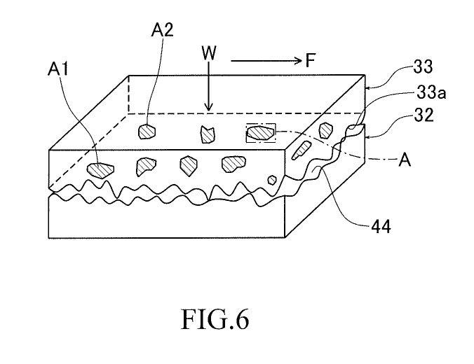

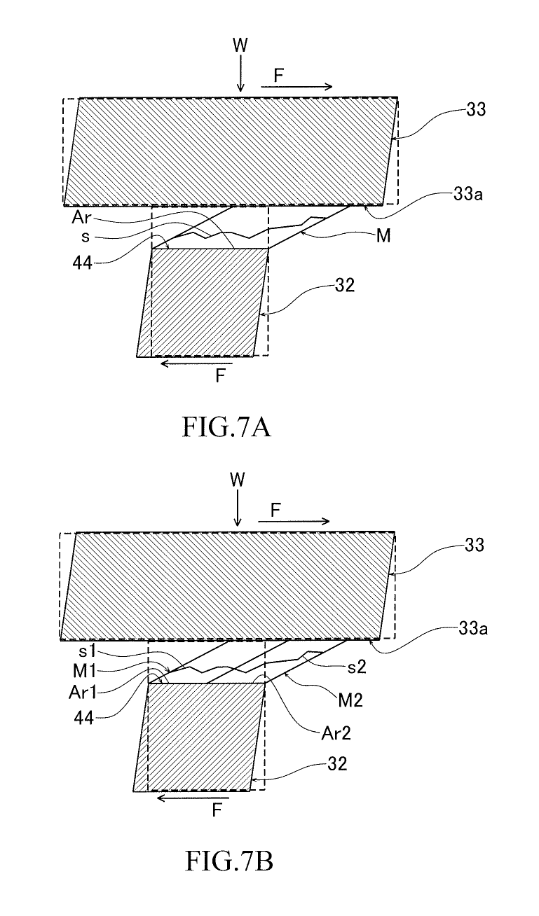

FIG. 6 schematically shows an actual contact surface due to a boundary film between the inner peripheral surface 33a of the metal ring 33 of the innermost periphery and the saddle surface 44 of the metal element 32 opposing to the inner peripheral surface 33a. In addition, FIG. 7 describes about the boundary film. FIG. 7A shows a case where there is one type of the boundary film, and FIG. 7B shows a case where there are two types of boundary films.

As shown in FIG. 7A, the following (Formula 1) shows a friction coefficient μ1 of the metal ring 33 in a case where there is just one type of boundary film M between the inner peripheral surface 33a of the metal ring 33 of the innermost periphery and the saddle surface 44 of the metal element 32.

$$μ ( Friction coefficient ) = \frac{F ( Friction force )}{W ( Vertical load )} = \frac{\begin{matrix}Ar ( Actual contact area ) \times \\ s ( Shearing Strength of boundary film M )\end{matrix}}{W} \qquad [ Formula 1 ]$$

In the formula, the friction force is F, a vertical load is W, an actual contact area of the boundary film M is Ar, and a shearing strength of the boundary film M is s. The friction coefficient μ1 of the metal rings 33 is F (the friction force)/W (the vertical load), and the friction force F in this case is Ar (the actual contact area)×s (the shearing strength of the boundary film M generated by a slide). Since the boundary film (a boundary lubrication firm) has a different film structure generated by a sliding material including an additive of working oil and a surface treatment, the shearing strength is also different.

That is, as understood from (Formula 1), the friction coefficient p1 of the metal ring 33 in a case where there is just one type of boundary film M depends on the shearing strength s of the boundary lubrication film generated by a slide. In addition, a life thereof depends on the surface treatment to a surface generated by the boundary lubrication film. Accordingly, a life of the surface treatment having a low friction coefficient is not always long, and both a low-friction coefficient and a long-life are difficult to achieve.

Whereas, as shown in FIG. 7B, the following (Formula 2) shows a friction coefficient ρ2 of the metal ring 33 in a case where there are two types of boundary films, a first boundary film M1 and a second boundary film M2, between the inner peripheral surface 33a of the metal ring 33 of the innermost periphery and the saddle surface 44 of the metal element 32.

$$μ 2 ( Friction coefficient ) = \frac{F ( Friction force )}{W ( Vertical load )} = \frac{\begin{matrix}Ar 1 ( Actual contact area ) \times \\ s 1 ( Shearing Strength of boundary film M )\end{matrix}}{W} + \frac{\begin{matrix}Ar 2 ( Actual contact area ) \times \\ s 2 ( Shearing Strength of boundary film M )\end{matrix}}{W} \qquad [ Formula 2 ]$$

As understood from (Formula 2), the friction coefficient ρ2 when there are two types of the boundary film is a sum of the two types of the friction coefficient, and a ratio of the two types of the friction coefficient depends on a ratio of actual contact areas Ar1, Ar2 of each boundary film M1, M2. Accordingly, by providing two types of boundary layers, which are a boundary layer generated on a surface of the projecting portion 38a capable of preventing occurrence of a crack and a boundary layer due to a surface treatment having a low-friction coefficient, a friction coefficient of the surface can be lowered and a life of the surface can be prolonged. Then, in the present embodiment, as described above, the boundary layer (the boundary film) between the metal ring 33 and the metal element 32 is configured to be a double layer (two types of boundary film) which is the above-described low-friction coefficient layer 51 and the surface layer of the projecting portion 38a (the high-friction coefficient layer).

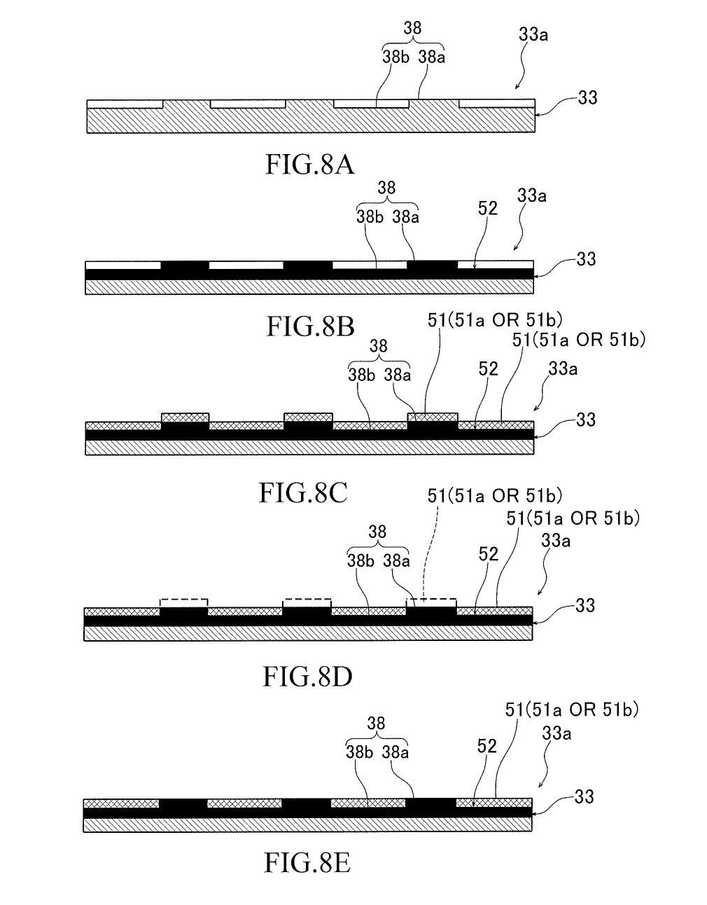

FIG. 8 describes a process of a surface treatment for forming the low-friction coefficient layer 51. Here, as an example, described is a case where the low-friction coefficient layer 51 is formed on the inner peripheral surface 33a of the metal ring 33 of the innermost periphery of the plurality of metal rings 33 configuring the metal ring assembly 31. In order to form the low-friction coefficient layer 51, first of all, as shown in FIG. 8A, the mesh-like uneven surface 38 having the plurality of projecting portions 38a and the plurality of valley portions 38b is formed on the inner peripheral surface 33a of the metal ring 33. Though a showing is omitted here, a form corresponding to the uneven surface 38 (the projecting portion 38a and the valley portion 38b) is formed in advance on a surface of a rolling roller (a pressing surface) for rolling the metal ring 33. The metal ring 33 is rolled by the rolling roller to form the uneven surface 38 on the inner peripheral surface 33a of the metal ring 33. Thereafter, a surface of the metal ring 33 is nitrided before forming the low-friction coefficient layer 51 to, as shown in FIG. 8B, to form a nitrided layer 52 as an underlayer of the low-friction coefficient layer 51. Thereafter, by applying a surface treatment for forming the low-friction coefficient layer 51 to the metal ring 33, as shown in FIG. 8C, the low-friction coefficient layer 51 is formed on surfaces of the projecting portion 38a and the valley portion 38b.

The above-described low friction coefficient layer 51 can be a fluoridated layer 51a formed by a fluoridation of the metal ring 33. In this case, the fluoridated layer 51a can be formed by exposing the metal ring 33 which is nitrided to atmosphere such as fluorine source gas.

In addition, the above-described low-friction coefficient layer 51 can be the layer 51b having the DLC film. The layer 51b having the DLC film can be formed by various methods publicly known and can use either a chemical vapor deposition (a CVD method) or a physical vapor deposition (a PVD method). Otherwise, the layer 51b having the DLC film may be formed by a method combining the CVD method and the PVD method. Furthermore, when using the CVD method, a thermal CVD, a plasma CVD, and others can be used. In addition, when using the PVD method, an ion plating, a sputtering method, and others can be used.

After the low-friction coefficient layer 51 (51a or 51b) is formed, as shown in FIG. 8D, a surface of the low-friction coefficient layer 51 is worn by a slide with another member to equalize a height of the surface and a height of a surface of the projecting portion 38a. As shown in FIG. 8E, this enables to eliminate the low-friction coefficient layer 51 of the surface of the projecting portion 38a, then the low-friction coefficient layer 51 is formed only on the valley portion 38b of the uneven portion 38. In addition, the low-friction coefficient layer 51 of the projecting portion 38a is not required to be completely eliminated in this process.

Here, in a process for manufacturing the metal belt 15, it is preferable that the low-friction coefficient layer 51 is worn by a slide and a height position of the surface thereof is equalized to a height position of the surface of the projecting portion 38a, thereby a film thickness of the low-friction coefficient layer 51 is equalized to or lowered than a thickness dimension of the uneven surface 33 (the mesh-like surface) (a height dimension of the projecting portion 38a against the valley portion 38b). However, in addition to the above, a film thickness of the low-friction coefficient layer 51 may be formed thicker than the thickness dimension of the uneven surface 33, and in a process of using the metal belt 15, the low-friction coefficient layer 51 raised higher than the projecting portion 38a is worn by a slide, thereby a surface of the low-friction coefficient layer 51 is equalized to or lowered than the thickness of the uneven surface 33. However, in this case, it is necessary for the low-friction coefficient layer 51 formed on the valley portion 38b not to be separated by a slide.

In the above-described manufacturing processes, the reason why a surface treatment by a fluoridation is performed after a nitridation is that a fluoridated layer is replaced with the nitrided layer when the fluoridation is performed before the nitridation. Here, by performing the fluoridation after the nitridation, not the fluoridation as a pretreatment of a nitridation in the nitridation, a fluoridated layer capable of reducing the friction coefficient can be formed on the valley portion 38b. In addition, in a case where the low-friction coefficient layer 51 is the layer 51b having the DLC film, when the DLC film is formed before the nitridation, nitrogen may be prevented from infiltrating into a preform when the nitridation is performed, and/or the DLC film may be deteriorated by heat in the nitridation.

In addition, in a case where the fluoridated layer 51b is selected as the low-friction coefficient layer 51, the fluoridation is performed again as a following process of the nitridation after the fluoridation. Accordingly, since the necessity of adding equipment and changing a process required to the fluoridation can be eliminated, costs for manufacturing the metal ring 33 and the metal belt 15 can be avoided from rising.

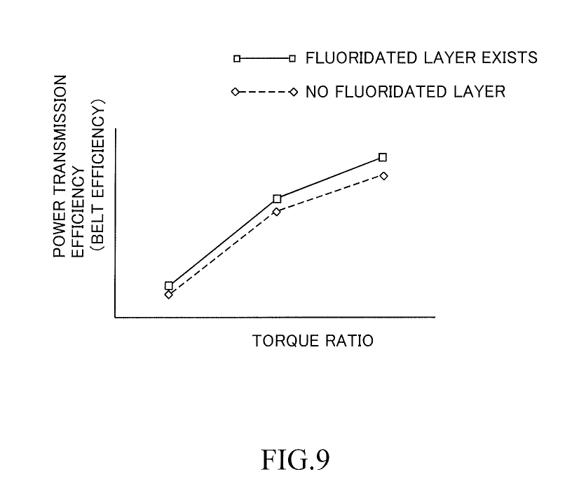

FIG. 9 is a graph for showing a comparison of a power transmission efficiency (a belt efficiency) of the metal belt 15 in a case where there is a fluoridated layer Ma and there is not the fluoridated layer Ma. In the graph of the figure, a torque ratio of the metal belt continuously variable transmission T is taken on a horizontal shaft, and the power transmission efficiency (the belt efficiency) of the metal belt 15 is taken on a vertical shaft. Furthermore, the torque ratio described here shows a ratio of a current input torque to a maximum torque capable of being transmitted to the metal belt continuously variable transmission T. In addition, the power transmission efficiency of the metal belt 15 on which the fluoridated layer Ma is formed as the low-friction coefficient layer 51 is shown by a solid line, and the power transmission efficiency of the metal belt 15 on which the fluoridated layer 51a is not formed is shown by a dotted line. As shown in the graph, in the metal belt 15 on which the fluoridated layer 51a is formed, in comparison with the metal belt 15 on which the fluoridated layer 51a is not formed, a friction resistance is lowered and the power transmission efficiency is improved.

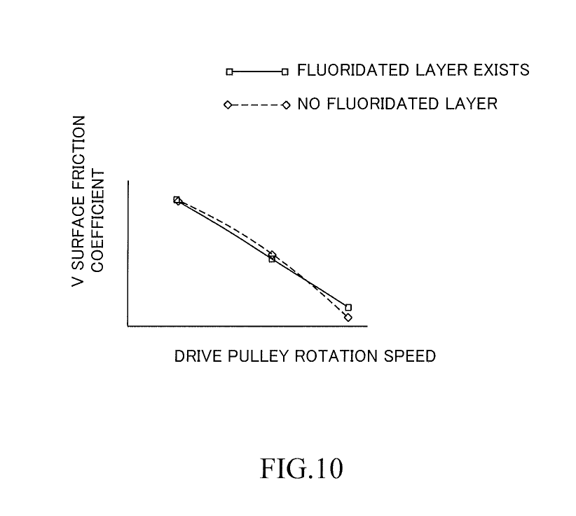

FIG. 10 is a graph for showing a comparison of a friction coefficient of V surfaces 6a, 11a of pulleys 6, 11 in a case where there is a fluoridated layer 51a and there is not the fluoridated layer 51a. In the metal belt continuously variable transmission T, a friction coefficient between the pulley abutting surface 39 of the metal element 32 and the V surfaces 6a, 11a of the pulleys 6, 11 is preferable to be a high friction coefficient originally. Whereas, as shown in the figure, even when the fluoridated layer 51a is formed as a surface treatment for reducing a friction coefficient of the metal ring 33, the friction coefficient between the pulley abutting surface 39 of the metal element 32 and the V surfaces 6a, 11 a of the pulleys 6, 11 is little influenced. Hence, according to the metal belt 15 having the fluoridated layer 51a as the low-friction coefficient layer 51 of the present embodiment, while maintaining a performance required to the metal belt continuously variable transmission T, the friction coefficient of the metal ring 33 is reduced to enhance the efficiency.

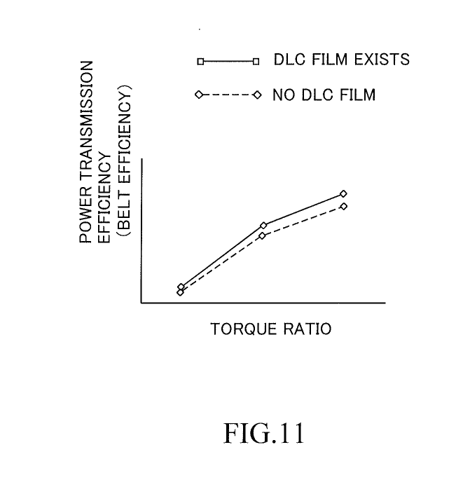

FIG. 11 is a graph for showing the power transmission efficiency (the belt efficiency) of the metal belt 15 in a case where there is the layer 51b having the DLC film and there is not the layer 51b. In the graph of the figure, a torque ratio of the metal belt continuously variable transmission T is taken on a horizontal shaft, and the power transmission efficiency (the belt efficiency) of the metal belt 15 is taken on a vertical shaft. In addition, the power transmission efficiency of the metal belt 15 on which the layer 51b having the DLC firm is formed as the low-friction coefficient layer 51 is shown by a solid line, and the power transmission efficiency of the metal belt 15 on which the layer 51b having the DLC film is not formed is shown by a dotted line. As shown in the graph of the figure, as well as the case of the fluoridated layer 51a, the friction coefficient of the metal belt 15 is more reduced in a case where there is the layer 51b having the DLC film than in a case where there is not the layer 51b, to improve the power transmission efficiency of the metal belt 15.

As described above, according to the metal belt 15 with which the metal belt continuously variable transmission T of the present embodiment is provided, by the low-friction coefficient layer 51 formed on the valley portion 38b of the uneven surface 38 of the metal ring 33, the friction coefficient of the metal ring 33 can be suppressed low. This enables to reduce a friction resistance due to a slide between the metal rings 33 or between the metal ring 33 and the metal element 32. Furthermore, the uneven surface 51 having the plurality of projecting portions 38a and the plurality of valley portions 38b is formed on a surface of the metal ring 33, thereby an average contact length w of a lateral direction (a width direction) of the projecting portion 38a after an initial wear is set to a given dimension to prevent a pitching occurred on a top of the projecting portion 38a when the projecting portion 38a is initially worn from extending in a depth direction. This enables to prevent a crack from occurring on the projecting portion 38a and improve a durability of the metal ring 33. Hence, both improving the durability of the metal ring 33 and reducing the friction resistance of the same can be achieved and the metal belt for the continuously variable transmission having a high strength and a high efficiency (a high transmission efficiency) can be provided.

In addition, in the metal belt 15 of the above-described configuration, as a friction resistance due to a differential rotation between members generated internally, the friction resistance generated on a contact position of the inner peripheral surface 33a of the metal ring 33 of the innermost periphery and the metal element 32 becomes the largest. Whereas, according to the above-described present embodiment, the uneven surface 38 is formed on the inner peripheral surface 33a of the metal ring 33 of the innermost periphery of the plurality of metal rings 33 and the low-friction coefficient layer 51 is formed on the valley portion 38b of the uneven surface 38, thereby the friction coefficient of the inner peripheral surface 33a of the metal ring 33 of the innermost periphery can be suppressed low. This enables to reduce the friction resistance generated between the metal ring assembly 31 and the metal element 32, and the power transmission efficiency (the belt efficiency) of the metal belt 15 can be improved.

In addition, in a case where the fluoridated layer 51a formed by a fluoridation is provided as the low-friction coefficient layer 51 for reducing a friction coefficient of the metal ring 33, the low-friction coefficient layer 51 of the present embodiment can be formed by performing a fluoridation again as a following process of a nitridation after a fluoridation in a nitridation. Accordingly, the necessity of adding equipment and changing a process required to the fluoridation for forming the low-friction coefficient layer 51 can be eliminated, to avoid rising of manufacturing cost for the metal ring 33 on which the low-friction coefficient layer 51 is formed and the metal belt 15. In addition, this enables to reduce a manufacturing cost of the metal belt continuously variable transmission T and a vehicle.

In addition, in a case of the fluoridation, the fluoridated layer is replaced with the nitrided layer when the fluoridation is performed before the nitridation, whereas the fluoridated layer can be securely formed without replacing the fluoridated layer with the nitrided layer by performing a surface treatment by the fluoridation after the nitridation. Accordingly, the fluoridated layer 51a capable of effectively reducing the friction coefficient can be formed on the valley portion 38b of the uneven surface 38.

In addition, when the layer 51b having the DLC film superior in a surface slidability as the low-friction coefficient layer 51 is formed on the valley portion 38b on the uneven surface 38 of the metal ring 33, a friction coefficient of the metal ring 33 can be effectively reduced.

In addition, according to the metal belt 15 of the present embodiment, the mesh-like uneven surface 38 having the plurality of the projecting portions 38a and the plurality of valley portions 38b is formed on the inner peripheral surface 33a of the metal ring 33 of the innermost periphery. And, when the projecting portion 38a of the uneven surface 38 is initially worn, the average contact length w of the projecting portion 38a measured in a direction at a right angle against an advancing direction thereof is set to be equal to or narrower than a given dimension on a position where the projecting portions 38a are not crossed with each other. This enables to prevent a pitching occurred on a top of the projecting portion 38a which is narrow from extending in a depth direction and prevent a crack from occurring by eliminating the shallow pitching by a wear due to a contact with the metal element 32. In addition, a width of the projecting portion 38a measured in a direction at a right angle against an advancing direction of the metal ring 33 is narrowed, a width of the projecting portion 38a measured in the advancing direction is also narrowed, thereby an oil film on the top of the projecting portion 38a is prevented from running out and an occurrence of a crack is prevented. When the metal ring 33 and the metal element 32 is attached, an average hertz surface pressure is lowered and a pitching is prevented. Also, a surface roughness is improved when the top of the projecting portion 38a is worn, thereby a lubricity is improved and a durability of the metal ring 33 is improved.

On the other hand, as described above, the low-friction coefficient layer 51 is formed on the valley portion 38b of the uneven surface 38, thereby a friction coefficient of the metal ring 33 can be reduced. Consequently, both reducing the friction coefficient of the metal ring 33 and improving the durability of the same can be achieved.

Though the embodiments of the present invention ware described above, the present invention is not limited to the above-described embodiments, and various deformations can be achieved within a scope of the technical ideas described in Claims, Specification, and Drawings. For example, in the above-described embodiments, though the mesh-like uneven surface 38 is formed only on the inner peripheral surface 33a of the metal ring 33 of the innermost periphery, other than this, the uneven surface 38 can be formed on an optional surface including an outer peripheral surface of the metal ring 33 of the innermost periphery, and an inner peripheral surface or an outer peripheral surface of another metal ring 33. In addition, a specific shape of the uneven surface 38 formed on the metal ring 33 is not always limited to a shape having a mesh-like projecting portion 38a and other shapes can be used.

Furthermore, in the present embodiment, though the low-friction coefficient layer 51 is the layer 51b having the fluoridated layer 51a formed by a fluoridation or having the DLC film, other than this, a similar effect can be obtained by providing, for example, a solid lubricant and the like such as a molybdenum disulfide to the valley portion 38b of the uneven surface 38.

1-6. (canceled)

7. A continuously variable transmission belt supporting a plurality of metal elements to a metal ring assembly obtained by laminating a plurality of metal rings in order to transmit a driving force between a drive pulley and a driven pulley, comprising:
an uneven surface having a plurality of projecting portions formed on a surface of the metal ring and a plurality of valley portions formed between the plurality of projecting portions;
wherein a low-friction coefficient layer having a lower friction coefficient on a surface of the same than a friction coefficient of a surface of the projecting portion is formed on the valley portion on the uneven surface; and
wherein a boundary layer of the plurality of the metal rings or the metal ring and the metal element is configured so as to be a double layer of the low-friction coefficient layer and a surface layer of the projecting portion.

8. The continuously variable transmission belt according to claim 7, wherein the uneven surface is configured to cross the plurality of mountainous projecting portions extending in an oblique direction to an advancing direction of the metal ring in a meshed state.

9. The continuously variable transmission belt according to claim 7, wherein the uneven surface is formed on an inner peripheral surface of the metal ring of the innermost periphery of the plurality of metal rings configuring the metal ring assembly.

10. The continuously variable transmission belt according to claim 7, wherein a nitrided layer is formed as an underlayer of the low-friction coefficient layer.

11. The continuously variable transmission belt according to claim 7, wherein the low-friction coefficient layer is a fluoridated layer.

12. The continuously variable transmission belt according to claim 7, wherein the low-friction coefficient layer comprises a DLC film.
